(19) United States
(12) Patent Application Publication
(10) Pub. No.: US 2012/0153891 A1
(43) Pub. Date: Jun. 21, 2012

(54) PORTABLE ELECTRONIC APPARATUS AND CIRCUIT AND METHOD FOR CHARGING RECHARGEABLE BATTERY THEREOF

(76) Inventors: Yung-Tai Yang, Taipei (TW); Wen-Jeng Fang, Taipei City (TW); Chien-Er Huang, Taipei (TW)

(21) Appl. No.: 13/404,017

(22) Filed: Feb. 24, 2012

Related U.S. Application Data
(63) Continuation-in-part of application No. 11/962,122, filed on Dec. 21, 2007.

(30) Foreign Application Priority Data
Nov. 7, 2007 (TW) 096142072

(51) Int. Cl. H02J 7/00

(52) U.S. Cl. 320/107; 320/160

(57) ABSTRACT

In a method of providing operating current to a portable electronic apparatus, a first connection terminal of the portable electronic apparatus is connected to a second connection terminal of a host, and interface type of the second connection terminal is determined. If the interface type is USB 2.0, the host provides a first operating current to the portable electronic apparatus for performing data read/write, and an internal rechargeable battery of the portable electronic apparatus provides a second operating current to the portable electronic apparatus. If the interface type is USB 3.0, the host provides a third operating current to the portable electronic apparatus for performing data read/write, and the third operating current selectively performs a charge process on the rechargeable battery. If the interface type is Wi-Fi, the rechargeable battery provides a fourth operating current to the portable electronic apparatus.

### CROSS REFERENCE TO RELATED APPLICATIONS

This application is a continuation-in-part of U.S. patent application Ser. No. 11/962,122, filed Dec. 21, 2007, which claims the priority benefit of Taiwan application serial no. 96142072, filed on Nov. 7, 2007. The entirety of the above-mentioned patent applications are hereby incorporated by reference herein and made a part of this specification.

### BACKGROUND

1. Technical Field

The present invention generally relates to a charging circuit and a charging method, and more particularly, to a portable electronic apparatus and a circuit and a method for charging the rechargeable battery thereof.

2. Description of the Conventional Art

Along with progress in science and technology, all kinds of electronic products are developed following trends toward high speed, high efficiency and light-slim-short-small design. In the above-mentioned developing stream, all kinds of portable electronic apparatuses, such as portable multimedia players (PMP), MP3 players and digital photo frames, have gradually come to dominate development, and play a major role in the market. Usually a portable electronic apparatus is equipped with a rechargeable battery to increase convenience of use and carrying, and enhance the practicability thereof.

Since any operation of a portable electronic apparatus, such as reading/writing data, needs current to avoid a possible fault, during charging a rechargeable battery of a portable electronic apparatus, the apparatus usually shares a portion of the current as a charging current, while the remaining portion of the current serves for the portable electronic apparatus to execute any action at the time. However, a portable electronic apparatus does not stay in an operating state all the time. Thus, once a portable electronic apparatus enters a non-operating state, a larger portion of a charging current can be used to charge the rechargeable battery, and the net charging time can be effectively shortened.

### SUMMARY

According to an embodiment, a method of providing operating current to a portable electronic apparatus comprises: connecting a first connection terminal of the portable electronic apparatus to a second connection terminal of a host; detecting interface type of the second connection terminal; if the interface type of the second connection terminal is USB 2.0, the host providing a first operating current to the portable electronic apparatus for performing data read/write, and an internal rechargeable battery of the portable electronic apparatus providing a second operating current to the portable electronic apparatus; if the interface type of the second connection terminal is USB 3.0, the host providing a third operating current to the portable electronic apparatus for performing data read/write, and the third operating current selectively performing a charge process on the rechargeable battery; and if the interface type of the second connection terminal is Wi-Fi, the rechargeable battery providing a fourth operating current to the portable electronic apparatus.

According to an embodiment, a method of charging an electronic device externally connected to a portable electronic apparatus comprises detecting whether a first connection terminal of the portable electronic apparatus is connected to a second connection terminal of a host, and providing a recharge current to the electronic device for performing a charging process by the rechargeable battery if the first connection terminal is not connected to the second connection terminal.

According to an embodiment, a portable electronic apparatus comprises a memory unit, a memory controlling unit, coupled to the memory unit for performing an operation on the memory unit, a charging unit electrically connected to the memory controlling unit, and a rechargeable battery electrically connected to the charging unit. The portable electronic apparatus further comprises a processor for connecting to a host, detecting interface type of a connection terminal of the host, and controlling operation of the processor, the charging circuit and the rechargeable battery according to the following conditions: (1) if the interface type is USB 2.0, receiving a first operating current from the host, providing the first operating current to the portable electronic apparatus for performing data read/write, and controlling the rechargeable battery to provide a second operating current to the portable electronic apparatus; (2) if the interface type is USB 3.0, receiving a third operating current from the host, providing the third operating current to the portable electronic apparatus for performing data read/write, and selectively performing a charge process on the rechargeable battery by the third operating current; and (3) if the interface type is Wi-Fi, providing a fourth operating current to the portable electronic apparatus by the rechargeable battery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a portable electronic apparatus capable of dynamically adjusting the charging current according to the embodiment of the present invention.

FIG. 2 is a flowchart of a charging method of a rechargeable battery according to the embodiment of the present invention.

FIG. 3 is a diagram illustrating a portable electronic apparatus according to another embodiment of the present invention.

FIG. 4 is a diagram illustrating a portable electronic apparatus according to another embodiment of the present invention.

FIG. 5 is a flowchart of a process for providing operating current to a portable electronic apparatus according to the embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

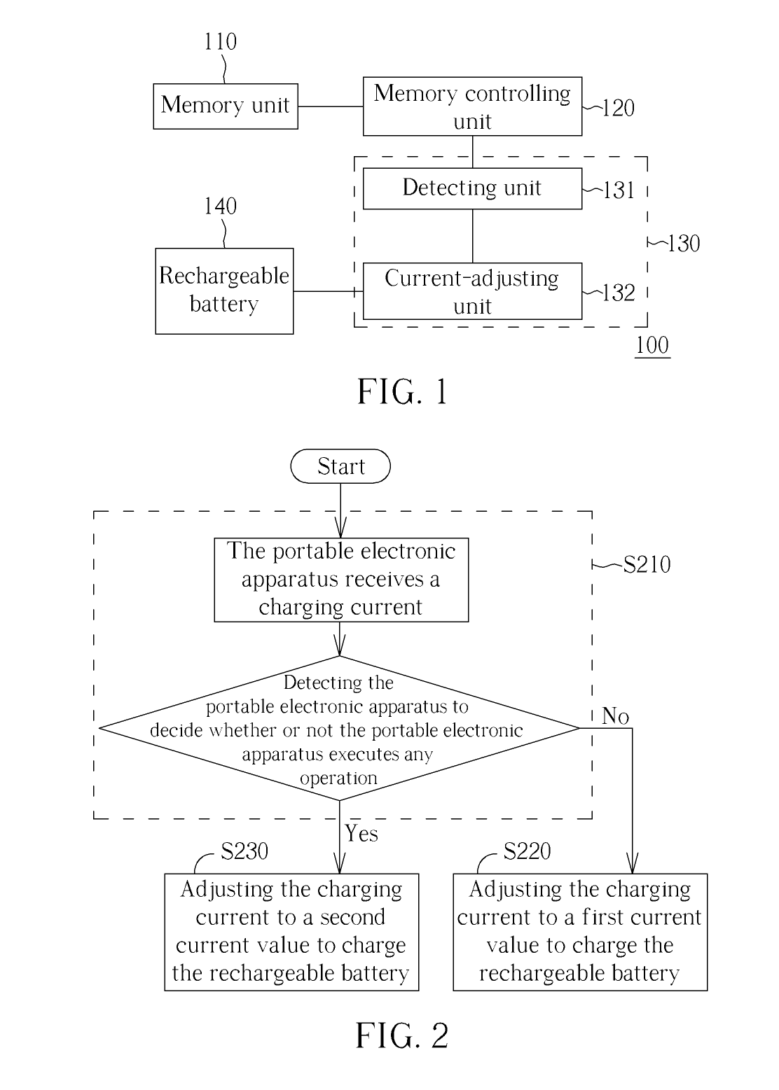

FIG. 1 is a diagram of a portable electronic apparatus capable of dynamically adjusting the charging current according to the embodiment of the present invention. Referring to FIG. 1, a portable electronic apparatus 100 provided by the present invention includes a memory unit 110, a memory controlling unit 120, a charging circuit 130 and a rechargeable battery 140, wherein the charging circuit 130 includes a detecting unit 131 and a current-adjusting unit 132 for adjusting the charging current in the portable electronic apparatus 100.

In the embodiment, the portable electronic apparatus 100 can be, but not limited to by the present invention, portable multimedia player (PMP), MP3 player or digital photo frame and so on. The memory unit 110 can be a non-volatile memory, for example, a flash memory, for storing the data required by a user. Besides, the rechargeable battery 140 can be nickel-metal hydride battery, solar battery or lithium battery.

Continuing to FIG. 1, the memory controlling unit 120 is coupled to the memory unit 110 for reading/writing the data thereof. The detecting unit 131 is coupled to the memory controlling unit 120 for detecting whether or not the portable electronic apparatus 100 executes an operation and thereby generating a detection result. In the embodiment, the above-mentioned operation of the portable electronic apparatus 100 is, but not limited to by the present invention, for example, reading/writing data from the memory unit 110 or playing music.

For example, when the detecting unit 131 finds out by detecting that the portable electronic apparatus 100 may not execute any operation, a first signal is generated, which serves as a basis to indicate that no operation is executed by the portable electronic apparatus 100. When the detecting unit 131 finds out the portable electronic apparatus 100 is executing an operation, a second signal is generated, which serves as a basis to indicate that the portable electronic apparatus 100 is executing an operation. The first signal and the second signal herein are the detection result generated by the detecting unit 131.

The current-adjusting unit 132 is coupled to the detecting unit 131 for correspondingly adjusting the amount of the charging current according to the detection result. For example, if the current-adjusting unit 132 receives the first signal, it means the portable electronic apparatus 100 does not execute any operation, thus, the current-adjusting unit 132 accordingly outputs a first current to charge the rechargeable battery 140.

In contrast, if the current-adjusting unit 132 receives the second signal, it means the portable electronic apparatus 100 is executing an operation, thus, the current-adjusting unit 132 accordingly outputs a second current to charge the rechargeable battery 140. In the embodiment, the first current value is greater than the second current value. In this way, the present invention is able to solidly speed the charging course resulting in a reduced charging time by adjusting the charging current, further preventing the portable electronic apparatus 100 from malfunction due to insufficient current provided for executing an operation.

In the following, another embodiment (not shown) is depicted to explain how the portable electronic apparatus 100 adjusts the charging current. First, it is assumed a computer system (not shown) is able to provide a current of about 500 mA through a connection interface (not shown), wherein the connection interface is, for example, a USB (universal serial bus) interface. When the portable electronic apparatus 100 is connected to the computer system through the connection interface for charging, the detecting unit 131 immediately begins performing detection on the portable electronic apparatus 100. That is to say, the detecting unit 131 starts to perform detection on the portable electronic apparatus 100 to determine whether or not an operation of reading/writing data is conducted.

If the detection result indicates the portable electronic apparatus 100 is reading data, the current-adjusting unit 132 correspondingly outputs a current of about 250 mA to charge the rechargeable battery 140, while another current of about 250 mA is provided to the portable electronic apparatus 100 for reading data so as to avoid a possible malfunction during reading/writing data due to insufficient current.

In addition, if the detection result indicates the portable electronic apparatus 100 unlikely conducts reading/writing data, the current-adjusting unit 132 correspondingly outputs a current of about 400 mA (i.e. the current is increased from about 250 mA to about 400 mA) so as to speed up the charging course of the rechargeable battery 140, resulting in a reduced charging time.

In the above-mentioned embodiment, the operation of the portable electronic apparatus 100 is exemplarily reading/writing data, based on which the charging current is adjusted. However, the present invention does not limit reading data. Any other operation of the portable electronic apparatus 100, for example, playing music, is also considered, and the charging current can be adjusted referring to the above description.

From the depiction of the above-mentioned embodiment, a charging method of a rechargeable battery can be extracted, as shown by FIG. 2. The charging method of the present invention is suitable for the above-mentioned portable electronic apparatus 100. Referring to FIG. 2, first in step S210, when a portable electronic apparatus receives a charging current, detection is performed on the portable electronic apparatus to determine whether or not an operation is conducted (for example, reading/writing data or playing music).

Next, in step S220, when it is determined that the portable electronic apparatus does not execute any operation, the charging current is adjusted to be a first current value so as to charge a rechargeable battery. Then in step S230, when it is found the portable electronic apparatus is executing an operation, the charging current is adjusted to be a second current value to charge the rechargeable battery, wherein the first current value is greater than the second current value.

In summary the present invention employs a detecting unit to detect whether or not the portable electronic apparatus executes any operation, for example, reading/writing data or playing music and uses the detection result as the basis to adjust the charging current. When it is found that the portable electronic apparatus does not execute any operation, the current-adjusting unit makes the charging current larger to enhance the charging efficiency of the rechargeable battery and speed the charging course. When it is found that the portable electronic apparatus execute an operation, the current-adjusting unit makes the charging circuit smaller so as to prevent the portable electronic apparatus from malfunction due to insufficient current provided for executing an operation. In short, the present invention is able to improve the charging efficiency to shorten the charging course and avoid a possible malfunction during a charging course.

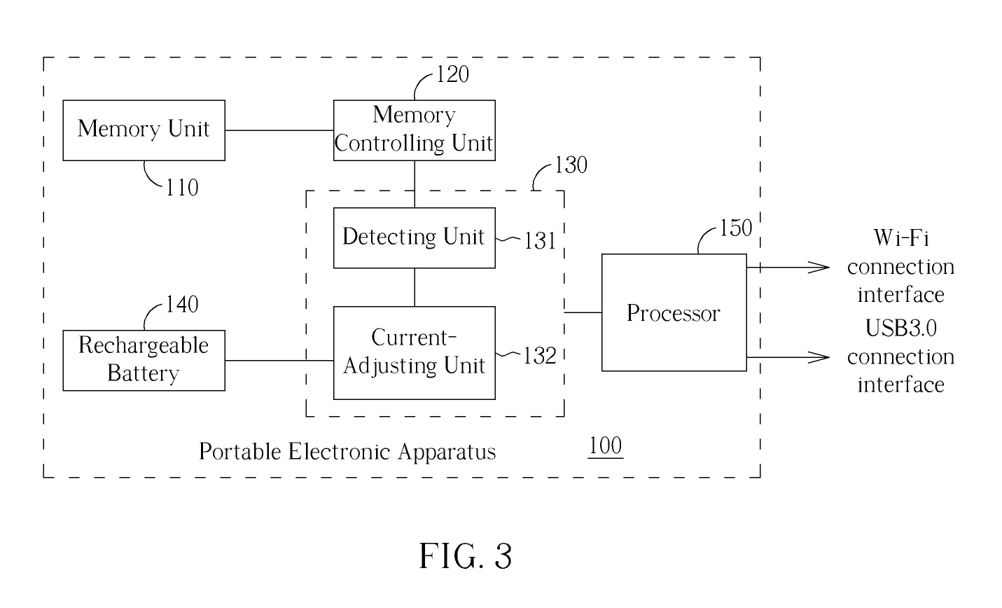

Please refer to FIG. 3, which is a diagram illustrating portable electronic apparatus 100 in another embodiment. Similar reference numerals in FIG. 1 and FIG. 3 indicate similar components having similar structure and/or function. Portable electronic apparatus 100 may be a portable storage device, and further includes processor 150. Processor 150 and memory controlling unit 120 may be integrated into a single component. Processor 150 is electrically connected to charging circuit 130, and has external connections through a USB 3.0 connection interface and a Wi-Fi connection interface for use in connecting to a host, e.g. a personal computer (PC) or a smart mobile phone. When connection to the host is made through the USB 3.0 connection interface of portable electronic apparatus 100, processor 150 detects whether the host is a USB 2.0 or USB 3.0 host, and generates and provides different signals to charging circuit 130 accordingly. When the host is a USB 2.0 host, due to only being able to provide 500 mA of current, operating current needed by memory controlling unit 120 to perform data read/write on memory unit 110 may be insufficient, e.g. for a high spin rate hard disk drive (HDD). Thus, at this time, rechargeable battery 140 supplements operating current. When memory controlling unit 120 does not perform data read/write on memory unit 110, 500 mA current provided by host is provided to rechargeable battery 140 for use in charging. This presents two states for rechargeable battery 140, namely a power providing state and a charging state. When the host is a USB 3.0 host, due to being able to provide 900 mA of current, rechargeable battery 140 does not need to supplement operating current. Thus, a portion of the 900 mA of current provided by the host may be provided to rechargeable battery 140 to perform charging. At this time, rechargeable battery 140 has only one state (charging). When connection to the host is made through the Wi-Fi connection interface, all operating current needed for memory controlling unit 120 to perform data read/write on memory unit 110 is provided by rechargeable battery 140. At this time, rechargeable battery 140 only has one state (providing power).

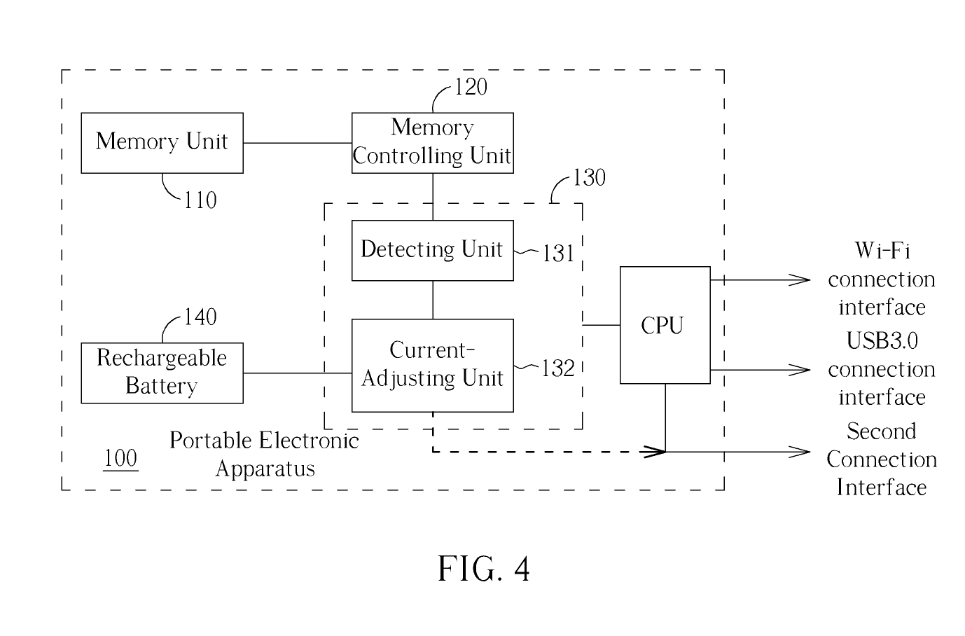

Please refer to FIG. 4, which is a diagram of portable electronic apparatus 100 according to another embodiment. Similar reference numerals in FIG. 1, FIG. 3, and/or FIG. 4 indicate similar components having similar structure and/or function. Similar to FIG. 3, in the embodiment shown in FIG. 4, portable electronic apparatus 100 includes processor 150. In addition to external connections to Wi-Fi and USB 3.0 connection interfaces, processor 150 is further able to connect to other electronic devices through a second connection interface. When processor 150 detects that second connection interface is connected to another electronic device, e.g. a mobile phone or media player, and USB 3.0 connection interface and Wi-Fi connection interface are not connected to a host, the portable electronic apparatus 100 acts as a power bank, and can use rechargeable battery 140 to perform charging on the another electronic device. In the above, the condition/limitation that the “USB 3.0 connection interface and Wi-Fi connection interface are not connected to a host” is included to prevent rechargeable battery 140 from reduced discharge efficiency due to simultaneously providing operating current.

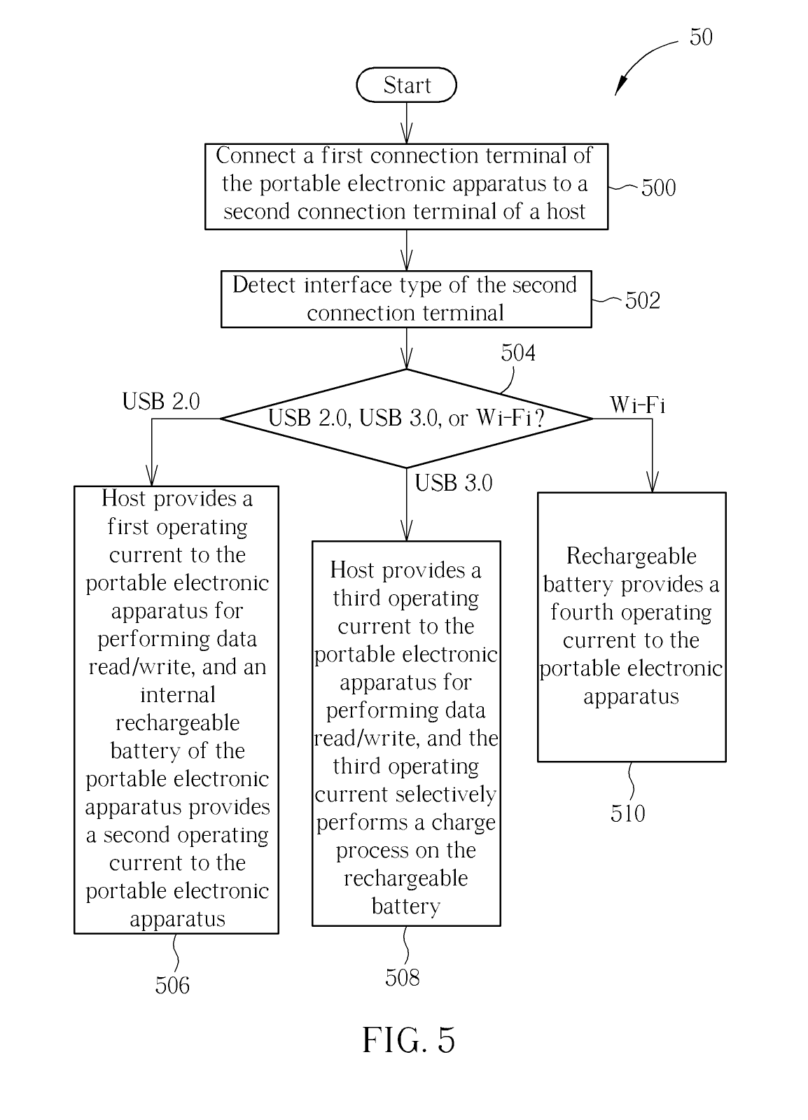

Please refer to FIG. 5, which is a flow chart of a process 50 for providing operating current to a portable electronic apparatus. The process 50 may be implemented in embodiments of portable electronic apparatus 100 shown in FIG. 3 and FIG. 4, and includes the following steps:

Step 500: Connect a first connection terminal of the portable electronic apparatus to a second connection terminal of a host;

Step 502: Detect interface type of the second connection terminal;

Step 504: Is the interface type USB 2.0, USB 3.0, or Wi-Fi? If USB 2.0, go to step 506; if USB 3.0, go to step 508; if Wi-Fi, go to step 510;

Step 506: Host provides a first operating current to the portable electronic apparatus for performing data read/write, and an internal rechargeable battery of the portable electronic apparatus provides a second operating current to the portable electronic apparatus;

Step 508: Host provides a third operating current to the portable electronic apparatus for performing data read/write, and the third operating current selectively performs a charge process on the rechargeable battery; and

Step 510: Rechargeable battery provides a fourth operating current to the portable electronic apparatus.

In step 500, the first connection terminal may be a connection terminal of processor 150 used for making a connection to the host through the USB 3.0 connection interface or the Wi-Fi connection interface. The interface type is detected in step 502, and the method provides three modes (steps 506, 508, 510) for handling the various connection scenarios described above. For example, when the host is a USB 2.0 host, the host provides first operating current up to 500 mA, and the internal rechargeable battery 140 supplements the first operating current with the second operating current to ensure proper data read/write operation. If the host is a USB 3.0 host, the host provides the third operating current up to 900 mA, and the third operating current may also be split to charge rechargeable battery 140 with a current <900 mA. If the host is connected through Wi-Fi, then no current is supplied by the host, and all operating current is provided by rechargeable battery 140.

In the embodiment of FIG. 4, it is also possible that no connection is made to an external host through either the USB 3.0 connection interface or the Wi-Fi connection interface, but a connection is made to an external device through the second connection interface. In this case, since the first connection terminal is not connected to the second connection terminal, rechargeable battery 140 provides a charge current to the electronic device for performing a charging process to charge the electronic device from the rechargeable battery 140.

By using the methods described above, portable electronic apparatus 100 has increased flexibility to charge rechargeable battery 140 when high current is provided by an externally connected device (USB 3.0), supplement current using the rechargeable battery 140 when low current is provided by an externally connected device (USB 2.0), and/or charge another external device connected through the second connection interface using the rechargeable battery 140. This provides greater convenience of use, while also preventing data read/write malfunction due to lower current.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of providing operating current to a portable electronic apparatus, the method comprising:
connecting a first connection terminal of the portable electronic apparatus to a second connection terminal of a host;
detecting interface type of the second connection terminal;
if the interface type of the second connection terminal is USB 2.0, providing a first operating current to the portable electronic apparatus for performing data read/write by the host, and providing a second operating current to the portable electronic apparatus by an internal rechargeable battery of the portable electronic apparatus;
if the interface type of the second connection terminal is USB 3.0, providing a third operating current to the portable electronic apparatus for performing data read/write by the host, and selectively performing a charge process on the rechargeable battery by the third operating current; and
if the interface type of the second connection terminal is Wi-Fi, providing a fourth operating current to the portable electronic apparatus by the rechargeable battery.

2. The method of claim 1, further comprising:
connecting a third terminal of the portable electronic apparatus to an electronic device;
detecting whether the first connection terminal is connected to the second connection terminal; and
providing a recharge current to the electronic device for performing a charging process by the rechargeable battery if the first connection terminal is not connected to the second connection terminal.

3. The method of claim 2, wherein connecting the third terminal of the portable electronic apparatus to the electronic device is connecting a third terminal of a processor of the portable electronic apparatus to the electronic device through a second connection interface.

4. The method of claim 1, wherein connecting the first connection terminal of the portable electronic apparatus to the second connection terminal of the host is connecting a first connection terminal of a processor of the portable electronic apparatus to the second connection terminal of the host through a connection interface of the interface type.

5. A portable electronic apparatus comprising:
a memory unit;
a memory controlling unit, coupled to the memory unit for performing an operation on the memory unit;
a charging unit electrically connected to the memory controlling unit;
a rechargeable battery electrically connected to the charging unit; and
a processor for connecting to a host, detecting interface type of a connection terminal of the host, and controlling operation of the processor, the charging circuit and the rechargeable battery according to the following conditions:
(1) if the interface type is USB 2.0, receiving a first operating current from the host, providing the first operating current to the portable electronic apparatus for performing data read/write, and controlling the rechargeable battery to provide a second operating current to the portable electronic apparatus;
(2) if the interface type is USB 3.0, receiving a third operating current from the host, providing the third operating current to the portable electronic apparatus for performing data read/write, and selectively performing a charge process on the rechargeable battery by the third operating current; and
(3) if the interface type is Wi-Fi, providing a fourth operating current to the portable electronic apparatus by the rechargeable battery.

6. The portable electronic apparatus of claim 5, wherein the processor further connects to an external electronic device, and further controls operation of the processor, the charging circuit and the rechargeable battery according to the following condition:
(4) if the processor is not connected to any host, providing a recharge current to the electronic device for performing a charging process by the rechargeable battery.

7. The portable electronic apparatus of claim 6, wherein the rechargeable battery has a power providing state for providing power to the electronic device when the processor is not connected to any host.

8. The portable electronic apparatus of claim 5, wherein the rechargeable battery has a power providing state for providing power for data read/write, and a charging state for being charged by the first operating current when no data read/write is occurring.

9. The portable electronic apparatus of claim 5, wherein the rechargeable battery has a charging state for being charged by the third operating current during data read/write.

10. A method of providing charging current to a rechargeable battery of a portable electronic apparatus, the method comprising:
connecting a first connection terminal of the portable electronic apparatus to a second connection terminal of a host;
detecting current amount provided from the second connection terminal of the host; and
selectively providing a charging current to the rechargeable battery based on the detected current amount while the portable electronic apparatus is in operating.

11. The method of claim 10, wherein the current amount provided from the second connection of the host comprises a first current amount and a second current amount, and the second current amount is larger than the first current amount.

12. The method of claim 11, wherein when the second current amount is provided from the second connection of the host, the charging current is provided to the rechargeable battery while the portable electronic apparatus is in operating.

13. The method of claim 11, wherein when the first current amount is provided from the second connection of the host, the rechargeable battery provides a third current to the portable electronic apparatus for operating.

14. A portable electronic apparatus comprising:
a memory controlling unit coupled to a memory unit for performing an operation on the memory unit;
a charging unit electrically connected to the memory controlling unit and a rechargeable battery; and
a processor electrically connected to the charging unit, and having a first type connection interface and a second type connection interface separately used for connecting to a host through a wire and a wireless connection, respectively;
wherein the rechargeable battery is selectively in a first and a second operation state based on a current amount provided by the host when the portable electronic apparatus connects to the host through the first type connection interface; and
wherein the rechargeable battery is in a third operation state when the portable electronic apparatus connects to the host through the second type connection interface.

15. The portable electronic apparatus of claim 14, wherein the first operation state of the rechargeable battery is a power providing/charging state to provide an operation current to the memory controlling for performing the operation on the memory unit and to receive a charging current from the host, and the second operation state of the rechargeable battery is a charging state to receive the charging current from the host.

16. The portable electronic apparatus of claim 15, wherein the third operation state of the rechargeable battery is a power providing state to provide the operation current to the memory controlling for performing the operation on the memory unit.

17. The portable electronic apparatus of claim 14, the processor further comprising a connection interface for connecting to an electronic device to provide a second charging current thereto when the first type connection interface or the second type connection interface are without connecting to the host.
